(19) United States
(12) Patent Application Publication
(10) Pub. No.: US 2006/0016271 A1
(43) Pub. Date: Jan. 26, 2006

(54) Method and apparatus for measuring the tack of pastelike substances

(76) Inventor: Frank Betzinger, Daubach (DE)

Correspondence Address: Timothy J. Klima;Harbin King & Klima, 500 Ninth Street SE, Washington, DC, 20003, US

(21) Appl. No.: 11/185,961

(22) Filed: Jul. 21, 2005

(30) Foreign Application Priority Data
Jul. 21, 2004 (DE) 10 2004 035 437.5

(51) Int. Cl. G01N 3/08

(52) U.S. Cl. 73/818

(57) ABSTRACT

A method and an apparatus for measuring the tack of pastelike substances, in particular printing inks, includes a drive roller (2) and a contact-pressure roller (3), between which the substance (5) to be measured can be introduced and uniformly distributed. To enable replicable measurement of the tack of pastelike substances (5), the invention proposes measuring the force exerted by the substance (5) on at least one predetermined surface region (6) of the drive roller (2) or of the contact-pressure roller (3), for instance by means of a highly dynamic miniature force sensor (7), directly in this surface region (6) as a function of the respective rotary angle (α) of the corresponding roller (2, 3), and then using this force course for determining the tack of the substance (5).

This application claims priority to German Patent Application No. 10 2004 035 437.5, filed Jul. 21, 2004, the entirety of which is incorporated by reference herein.

The invention relates to a method and an apparatus for measuring the tack of pastelike substances, particularly printing inks, as generically defined by the characteristics of the preamble to claim 1. The term “tack” (adhesiveness) means the peelability of a substance, applied as a film, for instance between two ink rollers.

Apparatuses for measuring the tack of inks are known for instance from German Patent DE 195 16 192 C1. They substantially comprise a contact-pressure roller, embodied as a measuring roller and coated with hard elastic, which is driven in frictional engagement by a metal roller (drive roller) revolving at a defined speed. A third friction roller, either driven or also entrained by frictional engagement, provides through traversing motions for a uniform distribution of the quantity of substance introduced into this arrangement for measuring tack.

Since the substance is compressed in the inflow region of the roller gap between the measuring roller and the drive roller and is subject to shear forces in the roller gap and is split in the outflow region, the resultant pressure, shear and cavitation stresses generate force components of the measuring roller that are compensated for in their totality by their bearing reaction force. From the bearing reaction force, which causes a tangential change of position of the measuring roller relative to the drive roller, the tack value of the substance to be tested is then obtained.

A disadvantage of this known method for determining the tack is that a distinction is not made between the force needed to build up the film between the rollers and the force needed to separate the film. The two forces are superimposed in the measurement. However, film buildup and film separation are based on different physical processes, so that a generally valid relationship between these processes cannot be established.

It has also been demonstrated that in the known methods, the properties of the elastomer-coated measuring roller can adversely affect the measurements and lead to relatively major measurement fluctuations. This is because the physical-chemical state of the elastomer layer depends greatly on its age, its former contact with solvent, and on current measuring conditions, such as temperature, contact pressures, and roller speed.

Finally, from German Patent DE 198 19 455 C2, an apparatus for measuring the tack of pastelike substances is known in which at least one measuring face that rotates with the respective roller and comprises an elastic material is secured to the outer surface of the drive roller or the contact-pressure roller. The measuring face is disposed on the surface of the applicable roller in such a way that because of the tack of the pastelike substance, it is lifted more or less markedly from the surface, and this lifting motion of the measuring face relative to the respective roller surface is measured with a measuring device that moves synchronously with the measuring face.

One disadvantage of using this kind of expansible measuring face, among others, is that the geometric shape of the gap changes during the tack measurement. Moreover, the masses of the measuring face that are in motion in the measurements lead to mechanical resonances, which can cause adulteration of the measurement results and must therefore be eliminated by relatively complicated additional provisions. Moreover, the expansible measuring face works counter to air pressure, which particularly at high speeds of rotation of the rollers can lead to further unwanted effects.

The object of the invention is to disclose a precisely functioning method for measuring the tack of pastelike substances, in which a distinction is made between the particular force that is needed for building up the film between the rollers and the force that is required for separating the film and that determines the actual tack. An apparatus for performing the method is also to be disclosed.

This object is attained according to the invention with respect to the method by the characteristics of claim 1 and with respect to the apparatus by the characteristics of claim 2. Further, especially advantageous features of the invention are disclosed in the dependent claims.

The invention is based substantially on the concept of measuring the force exerted by the pastelike substance on at least one predetermined surface region of the drive roller or contact-pressure roller, for instance by means of a highly dynamic miniature force sensor, directly in this surface region (and not, as in the case of DE 198 19 455 C2, on an additional measuring face that can be lifted from the corresponding roller surface), as a function of the applicable rotary angle of the corresponding roller, and using this force course then to determine the tack of the substance.

By means of this novel method, it is possible to distinguish exactly between film buildup and film separation. Moreover, a statement about the force distribution can be made as a function of the applicable rotary angle. Finally, no significant influence on the tack measurement is exerted by the elastomer layer of the measuring roller.

It has proved advantageous if a force sensor, such as a piezoelectric element, that is disposed rigidly relative to the corresponding roller is integrated directly with the respective predetermined surface region of the drive roller or the contact-pressure roller.

Compared to the use of a measuring surface that can be lifted from the applicable roller surface, as described in DE 198 19 455 C2, the apparatus of the invention, in which the force acting on the surface of one of the rollers is measured, has the advantages, among others, that it functions practically without wear, that it enables an exact resolution of compressive and tensile forces, and that no internal mechanical friction and no friction between adjacent parts occurs. Moreover, with the apparatus of the invention, very high measuring dynamics (>500 kHz) is attained, which is of great significance, given printing machines that are becoming faster and faster (up to 20 m/s).

In an embodiment of the apparatus of the invention, in the roller in which the respective force sensor is disposed, a measurement variable detection device is provided, which digitizes the analog measured values and, optionally after preprocessing, transmits them in wireless fashion to an evaluation device located outside the roller.

Further details and advantages will become apparent from the ensuing exemplary embodiments described in conjunction with the drawings.

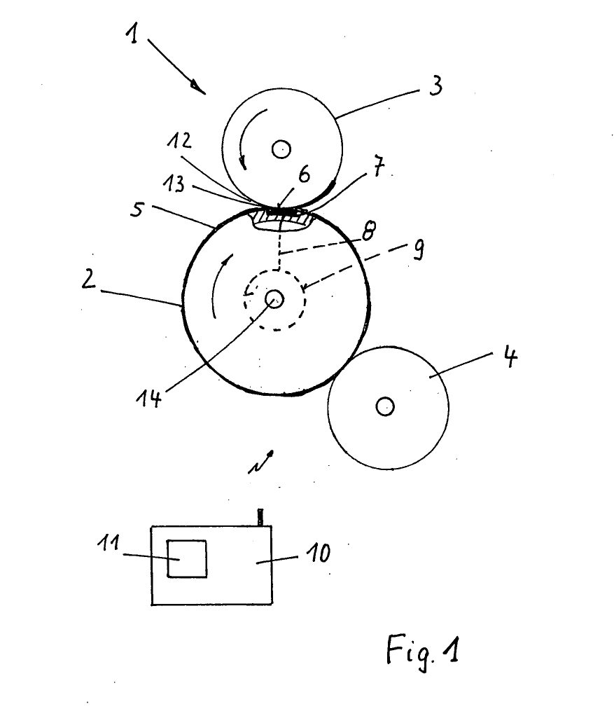

FIG. 1 schematically shows a side view of an apparatus of the invention, with a drive roller containing a force sensor;

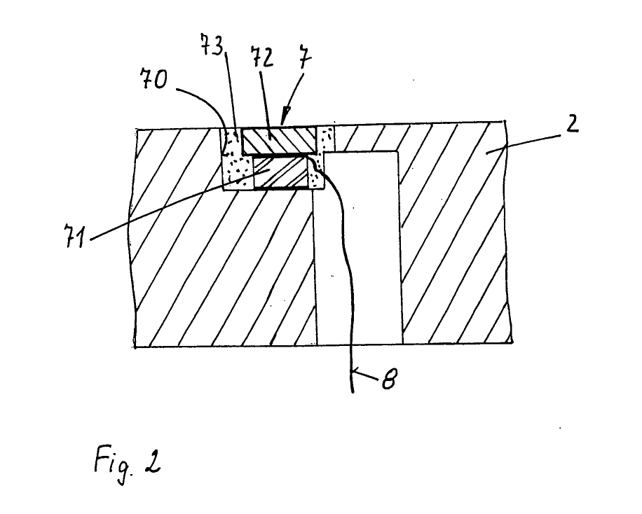

FIG. 2 is an enlarged detail of the drive roller shown in FIG. 1, in the region of the force sensor;

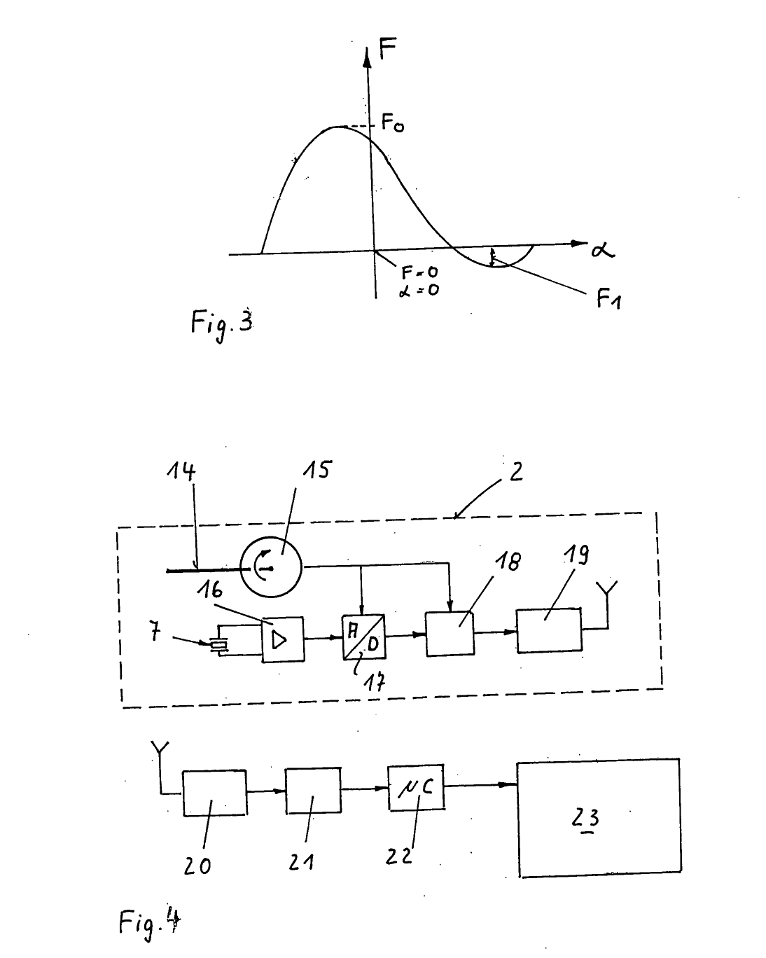

FIG. 3 shows the measured course over time of the force in the region of the surface of the drive roller in which the force sensor is disposed; and

FIG. 4 shows an electronic measurement variable detection device, connected to the force sensor and likewise located in the drive roller, which is connected in wireless fashion to an evaluation device located outside the drive roller.

In FIG. 1, reference numeral 1 designates an apparatus according to the invention, which substantially comprises a metal drive roller 2, a contact-pressure roller 3 coated with hard elastic, and a likewise entrained roller 4, which by traversing motions assures uniform distribution of a printing ink 5 applied to the drive roller 2. The contact-pressure roller 3 and the distribution roller 4 are joined by frictional engagement to the drive roller 2 embodied as a measuring roller and are driven by that roller.

According to the invention, in a relatively narrow surface region 6 of the drive roller 2, a highly dynamic miniature force sensor 7 is now located in a recess 70 of the drive roller 2; it detects both compressive and tensile forces (FIG. 2). This force sensor 7 substantially comprises a piezoelectric element 71, which is adjoined, on the side toward the contact-pressure roller 3, by a head part 72. The remaining space in the recess 70 is filled with a filler material 73. The piezoelectric element 71 is connected electrically, via an electric line 8, to a measurement variable detection device 9 (FIG. 1) located in the drive roller 2, and the power supply to this detection device is effected via an electromagnetic alternating field coupled laterally into the drive roller 2.

The measurement data, evaluated and digitized by the measurement variable detection device 9, are then transmitted in wireless fashion, for instance by radio, to an evaluation device 10 located outside the drive roller 2 and are further processed by it and displayed on a screen 11 and/or printed out on a printer (not shown).

FIG. 3 shows the typical course of the force F, measured with the force sensor 7, as a function of the rotary angle α of the drive roller 2. In the inflow region 12 of the gap 13 between the drive roller 2 and the contact-pressure roller 3 (FIG. 1), the ink is compressed, and the force (compressive force), beginning at a starting value F=0, initially increases constantly as a function of the width of the roller gap 13.

Once a maximal force F₀ is reached, the force then decreases again and finally reaches negative values (tensile force). These tensile forces are the forces which are required for separating the ink film and which define the tack. Once the maximal tensile force F1 (maximal tack value) is reached, the force F then rises again to its starting value (F=0).

Information can therefore be learned from the measured force course, such as:
width of the roller gap
duration of the film buildup process
peak force and integrated force for the film buildup process
duration of the film separation process
peak force and integrated force for the film separation process (maximal value for tack and integral tack)
statistical fluctuations of the final angle upon separation (tendency toward thread formation and misting)

FIG. 4 shows a block circuit diagram of the measurement variable detection device 9 and the evaluation device 10. The measurement variable detection device 9 includes on the one hand a rotary angle transducer 15, operatively connected to the pivot shaft 14 of the drive roller 2, and on the other hand a measurement arrangement having the force sensor 7, a measurement signal amplifier 16 downstream of the force sensor 7, and an analog/digital converter 17 downstream of the measurement signal amplifier.

The analog/digital converter 17 operates in time-discrete fashion; that is, the conversion of the measured, amplified analog signal into a digital value is done at predetermined instants. In the exemplary embodiment shown, the rotary angle transducer 15, as a function of the rotary angle α of the drive roller 2, generates electrical trigger signals, which thus at precisely predetermined angular positions trip the conversion of the analog signal into a digital value.

The digital signal is then expanded with additional information (such as the rotary angle) and provided with a code, required for the wireless signal transmission, in a coding device 18 and delivered to a transmission device 19.

The evaluation device 10 includes a receiver device 20, a decoding device 21 for decoding the received signals, and a microcomputer 22 for further processing of the decoded digital signals. In the microcomputer 22, among other things, operations for zero point compensation and an amplification in accordance with sensor calibration are then performed.

For further display and signal processing, a personal computer 23 is provided, preferably connected to the microcomputer 22 via a fast PC interface. With the aid of this personal computer 23, the calculation of the tack (maximal value of the tack, integral tack, and so forth) can then be performed.

It is understood that the invention is not limited to the exemplary embodiment described above. For instance, ascertaining the tack can also be done directly with the microcomputer 22.

Moreover, the transmission of the data ascertained by the measurement variable detection device 9 to the evaluation device 10 can be done via an infrared connection, for instance, instead of by radio.

In addition, the force sensor and the measurement variable detection device 9 may alternatively be located in the contact-pressure roller 3 instead.

For ascertaining the tack of the ink, a plurality of force sensors may also be disposed along the roller surface, and their measurement signals can be evaluated in parallel.

Finally, by suitable choice of materials for the head part of the force sensor and by suitable coating of the surface of the respective head part, conclusions about the dampening behavior for offset printing inks with emulsified dampening water can also be drawn.

In offset printing, the non-ink-bearing surfaces of the printing plate are in fact provided with a hydrophilic surface, while the ink-bearing surfaces are conversely provided with a hydrophobic (or oleophilic) surface. The printing ink preferentionally dampens the hydrophobic surface components of the printing plate (yielding an image), while the dampening water conversely preferentially dampens the hydrophilic surface components.

Therefore if the surface of the head part of a first force sensor is coated (for instance by chrome plating) with a hydrophilic material, and the surface of the head part of a second force sensor is coated by nickel plating with an oleophilic material, then the printing ink and dampening water in an emulsion applied to the drive roller become differently deposited on the head parts of the force sensors. Since markedly higher forces are required for separating a film of printing ink than for separating a water film, information on the dampening behavior of emulsified offset printing inks on different surfaces can thus be obtained.

### List of Reference Numerals

1 Apparatus
2 Roller, drive roller
3 Roller, contact-pressure roller
4 Roller, distribution roller
5 Substance, printing ink
6 Surface region
7 Force sensor, miniature force sensor
8 Electric line
9 Measurement variable detection device
10 Evaluation device
11 Screen
12 Inflow region
13 Gap
14 Pivot shaft
15 Rotary angle transducer
16 Measurement signal amplifier
17 Analog/digital converter
18 Coding device
19 Transmission device
20 Receiver device
21 Decoding device
22 Microcomputer
23 Personal computer
70 Recess
71 Piezoelectric element
72 Head part
73 Filler material
F Force
α Rotary angle

1. A method for measuring the tack of pastelike substances, in particular printing inks, having a drive roller (2) and a contact-pressure roller (3), between which the substance (5) to be measured can be introduced and uniformly distributed, characterized in that the force acting by means of the pastelike substance (5) on at least one predetermined surface region (6) of the drive roller (2) or of the contact-pressure roller (3) is measured directly in this surface region (6) as a function of the respective rotary angle (α) of the corresponding roller (2, 3), and this force course is then used to determine the tack of the substance (5).

2. An apparatus for performing the method of claim 1, characterized in that at least one force sensor (7) disposed rigidly relative to the corresponding roller (2, 3) is integrated into the respective predetermined surface region (6) of the drive roller (2) or of the contact-pressure roller (3).

3. The apparatus of claim 2, characterized in that the respective force sensor (7) includes a piezoelectric element (71) and adjoining it a head part (72) oriented toward the surface of the corresponding roller (2, 3).

4. The apparatus of claim 3, characterized in that at least two force sensors (7) are disposed along the surface of the drive roller (2) or of the contact-pressure roller (3), and that the surface of the head part (72) of the one force sensor comprises a hydrophilic material, and the surface of the head part (72) of the other force sensor comprises an oleophilic material.

5. The apparatus of claim 2, characterized in that in the roller (2, 3) in which the respective force sensor (7) is disposed, a measurement variable detection device (9) is provided, which digitizes the analog measured values and, optionally after preprocessing, transmits them in wireless fashion to an evaluation device (10) located outside the roller (2, 3).

6. The apparatus of claim 3, characterized in that in the roller (2, 3) in which the respective force sensor (7) is disposed, a measurement variable detection device (9) is provided, which digitizes the analog measured values and, optionally after preprocessing, transmits them in wireless fashion to an evaluation device (10) located outside the roller (2, 3).

7. The apparatus of claim 4, characterized in that in the roller (2, 3) in which the respective force sensor (7) is disposed, a measurement variable detection device (9) is provided, which digitizes the analog measured values and, optionally after preprocessing, transmits them in wireless fashion to an evaluation device (10) located outside the roller (2, 3).
